(19) United States
(12) Patent Application Publication
(10) Pub. No.: US 2009/0017332 A1
(43) Pub. Date: Jan. 15, 2009

(54) CRYSTALLINE TERNARY CERAMIC PRECURSORS

(75) Inventors: Brich H. Kisi, New South Wales (AU); Daniel P. Riley, New South Wales (AU)

Correspondence Address: KNOBBE MARTENS OLSON & BEAR LLP, 2040 MAIN STREET, FOURTEENTH FLOOR, IRVINE, CA, 92614, US

(73) Assignee: NEWCASTLE INNOVATION LIMITED, Callaghan, NSW (AU)

(21) Appl. No.: 12/279,710

(22) PCT Filed: Feb. 16, 2007
(86) PCT No.: PCT/AU2007/000174

§ 371 Date: Aug. 15, 2008

(30) Foreign Application Priority Data
Feb. 17, 2006 (AU) 2006900802

(51) Int. Cl. B32B 9/04; C01B 21/00; C01B 31/36; C01B 31/30

(52) U.S. Cl. 428/697; 423/351; 423/414

(57) ABSTRACT

A method of forming Mₙ₊₁AXₙ, where M is an early transition metal (such as Ti) or mixtures thereof, A is a group III or IV element (such as Si) or mixtures thereof and X is C, N or mixtures thereof, the method comprising the steps of providing a precursor of formula Mₙ₊₁AXₙ and reacting the Mₙ₊₁Xₙ with A to provide Mₙ₊₁AXₙ. The Mₙ₊₁Xₙ may be ordered and/or twinned (eg by mechanical alloying, thermal treatment etc. prior to reacting with A, ordered and/or twinned during its formation from M and X. A may be present during the formation of Mₙ₊₁Xₙ from M and X or during the ordering and/or twinning of disordered Mₙ₊₁Xₙ. The Mₙ₊₁AXₙ produced is substantially free from MX and or other residual phases.

### FIELD OF THE INVENTION

The invention relates to metal ceramic hybrid compounds of general formula Mₙ₊₁AXₙ, such as Ti₃SiC₂, and to the methods of efficient synthesis of such compounds with controlled stoichiometry and purity.

### BACKGROUND ART

Compounds which exhibit both ceramic and metallic characteristics are of great interest as advanced materials. Metals are readily machined but can lose their machined form (especially cutting edges, for instance) at high temperatures. They are also subject to corrosion in chemical environments and oxidation at high temperatures. Ceramics on the other hand retain their shape at extremely high temperatures, but are brittle and difficult to machine at low temperatures. Considerable effort has been put into engineering advanced materials that posses the desired properties of both metals and ceramics.

One group of compounds that exhibit the desired hybrid metal ceramic properties are the “MAX” compounds. These are compounds of the general formula Mₙ₊₁AXₙ where M is an early transition metal, A is a group III or IV element, X is C or N and n is usually 1, 2 or 3. These materials are also commonly referred to as nano-laminates, or ternary Hägg and Nowotny phases. Although there are in excess of 100 such compounds, the most widely known Mₙ₊₁AXₙ compound is Ti₃SiC₂, titanium silicocarbide or titanium silicon carbide. The present invention will be generally described with reference to Ti₃SiC₂ as an example, although it will be appreciated that the scope of the invention is not limited to such an example but encompasses all compounds of the general Mₙ₊₁AXₙ formula.

Mₙ₊₁AXₙ compounds, including Ti₃SiC₂, exhibit high fracture toughness at elevated temperatures, and can be machined using conventional hard steel tooling. They have high temperature stability, high temperature strength (Compressive: 500 MPa at 1573K, Bend: 120 MPa at 1573K, Tensile: 60 MPa at 1473K) and chemical stability (E(O₂)≅370 kJ/mol) similar to ceramics. The Young's modulus is (320 GPa) and, unlike other ceramics, they possess extreme thermal shock resistance (ΔT>1673K) and high thermal conductivity (34 W/m.K). These attributes make them useful in mechanical applications whereas their high electrical conductivity (4.5×10⁶ Ω⁻¹m⁻¹) is suited to electrical applications. Together these represent an exciting combination of material properties.

It is believed that the layered structure of Mₙ₊₁AXₙ compounds, including Ti₃SiC₂, is the key to these compounds achieving this desirable combination of properties. There is solid evidence throughout the literature that the properties of other Mₙ₊₁AXₙ compounds are very similar to those of Ti₃SiC₂, in particular other 3:1:2 compounds, but equally 2:1:1 and 4:1:3 compounds.

The scientific literature teaches that pure Ti₃SiC₂ is suitable for a diverse range of applications, including structural ceramics, corrosion/oxidation resistant films, or as an interlayer phase in bonding ceramics and metals. Composite materials where a MAX compound forms the majority phase that bonds together another phase with different properties are also of considerable utility in abrasive environments. An example would be Ti₃SiC₂ with a controlled quantity and dispersion of TiC. However, reproducibly achieving controlled stoichiometry and homogeneity of sub-phases in MAX materials has proved difficult

However, there are drawbacks with currently available Mₙ₊₁AXₙ compounds, including Ti₃SiC₂, namely that:

i) known methods of synthesis do not allow for them to be obtained in ultra pure form (i.e. as a single compound).

The conventional synthesis of higher order (ternary, quaternary, etc) ceramic compounds such as Mₙ₊₁AXₙ compounds, including Ti₃SiC₂, requires that the reaction pathway proceeds via one or more intermediate phases. Residual intermediate phases are the major source of product imperfection, to the detriment of final material properties. When even minor impurity phases are present, the strength, oxidation resistance and ductility of the final Mₙ₊₁AXₙ compound are reduced. Reduced ductility leads to an increase in unpredictable fast fracture.

Because the reactions occur primarily in the solid phase, they are controlled by diffusion and the possibility exists of isolated, unreacted island of intermediate compounds remaining within the final product. It is generally the case that unwanted phases have high thermodynamic stability and are difficult (uneconomical) to remove from the solid matrix once formed.

ii) methods of synthesis require very high temperatures with associated economic and environmental cost.

The need to break down stable intermediate compounds such as Ti₅Si₃ to form the desired MAX compound requires considerable time at very high temperature, typically in the range (1400-1600° C.).

Consequently, in order to obtain improvements in product purity, reduced synthesis temperatures and reduced synthesis times, significant modification of synthesis techniques is required.

It is an object of the present invention to overcome or ameliorate at least one of the disadvantages of the prior art, or to provide a useful alternative.

Any discussion of the prior art throughout the specification should in no way be considered as an admission that such prior art is widely known or forms part of common general knowledge in the field.

### SUMMARY OF THE INVENTION

In a broad aspect, the invention provides a method of forming Mₙ₊₁AXₙ, where M is an early transition metal or mixtures thereof, A is a group III or IV element or mixtures thereof and X is C, N or mixtures thereof, the method comprising the steps of:

providing a precursor of formula Mₙ₊₁Xₙ and
reacting the Mₙ₊₁Xₙ with A to provide Mₙ₊₁AXₙ.

Mₙ₊₁Xₙ may be ordered and/or twinned prior to reacting with A. It may for instance be ordered and/or twinned during its formation from M and X, or alternatively Mₙ₊₁Xₙ is ordered and/or twinned by treatment of disordered Mₙ₊₁Xₙ.

Optionally, A is present during the formation of Mₙ₊₁Xₙ from M and X, or alternatively, A is present during the ordering and/or twinning of disordered Mₙ₊₁Xₙ.

Alternatively, A may be introduced immediately prior to, or during the reaction with Mₙ₊₁Xₙ.

According to a first aspect, the invention provides a method of forming Mₙ₊₁AXₙ, where M is an early transition metal or mixtures thereof, A is a group III or IV element or mixtures thereof and X is C, N or mixtures thereof, comprising:

providing a precursor of formula Mₙ₊₁Xₙ;
adding element A to the precursor of formula Mₙ₊₁Xₙ; and
treating the mixture of A and Mₙ₊₁Xₙ to provide Mₙ₊₁AXₙ.

The invention also provides a method of forming Mₙ₊₁AXₙ, where M is an early transition metal or mixtures thereof, A is a group III or IV element or mixtures thereof and X is C, N or mixtures thereof, comprising:

providing a precursor of formula Mₙ₊₁Xₙ;
treating Mₙ₊₁Xₙ if required to provide an ordered and/or twinned Mₙ₊₁Xₙ phase;
adding element A to the ordered Mₙ₊₁Xₙ phase; and
treating the mixture of A and Mₙ₊₁Xₙ to provide Mₙ₊₁AXₙ.

A may be for example Al, Si, P, S, Ga, Ge, As, Cd, In, Sn, Ti or Pb, but is preferably Si, Ge or Al. M is preferably Sc Ti V Cr, Zr, Nb, Mo, Hf, Ta or W. Most preferably, M is Ti.

A is preferably Si. X is preferably C. n may be any number, but is preferably an integer, preferably 1, 2, or 3, more preferably 2. The most preferred compound is Ti₃SiC₂, however the invention extends to the production of compounds within other ternary systems such as Ti—Ge—C systems, Ti—Al—C systems (including Tiₙ₊₁AlCₙ systems like Ti₂AlC, Ti₃AlC₂ and Ti₄AlC₃ which are also highly preferred compounds), Ti—Al—N systems, Ti—Si—N systems etc.

The precursor of formula Mₙ₊₁Xₙ; may be of any structure, for example, it may be disordered, ordered, twinned, alloyed. If desired, Mₙ₊₁Xₙ may be treated to provide an ordered and/or twinned Mₙ₊₁Xₙ phase.

Adding element A to the ordered Mₙ₊₁Xₙ phase may be, for instance, by mixing the two in powdered form. Alternatively, this may occur by gaseous phase or liquid phase mixing.

The process is extendable to solid solutions between MAX compounds where any or all of the M, A and X crystallographic sites are occupied by multiple elements for example, M can be any combination of early transition metals, such as a combination of Ti and V, A can be a combination of Si and Al, while X can be a combination of C and N.

Specific examples of such compounds include Ti₃SiₘAl₁₋ₘC₂, Ti_{y}V_{3-y}AlC₂ or Ti₃SiCₓN₂₋ₓ.

The process is also extendable to composite materials based upon MAX phases. An example is a matrix of Ti₃SiC₂ with embedded TiC particles.

The process is further extendable to oxide ceramics which have a layered structure such as the superconductor YBa₂Cu₃O_{7-δ} or the dielectric Ca₃Ti₂O₇.

Preferably, the treating of Mₙ₊₁Xₙ to provide an ordered and/or twinned Mₙ₊₁Xₙ phase is a mechanical treatment. Preferably the mechanical treatment is a milling treatment.

Alternatively, the treating of Mₙ₊₁Xₙ to provide an ordered and/or twinned Mₙ₊₁Xₙ phase is a thermal treatment. Preferably the thermal treatment is carried out in the range 600-1000° C.

Preferably, treating the mixture of A and Mₙ₊₁Xₙ to provide a Mₙ₊₁AXₙ is a thermal treatment sometimes referred to as reactive sintering or liquid phase sintering. The treatment may be carried out at any suitable temperature, and for any length of time. Preferably the thermal treatment is carried out about 1100° C. or below. In one embodiment, the thermal treatment is at temperatures between 400-1000° C. for between 30-60 minutes. In alternative preferred embodiments, the temperature is less than 500° C., with the process carried out for 100 minutes or more.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

According to a second aspect, the invention provides a method of forming Mₙ₊₁AXₙ where M is an early transition metal or mixtures thereof, A is Si, Ge, Al or mixtures thereof and X is C, N or mixtures thereof, comprising:

treating a mixture of n+1M and nX to provide an ordered and/or twinned Mₙ₊₁Xₙ phase
adding element A to the ordered Mₙ₊₁Xₙ phase
treating the mixture of A and Mₙ₊₁Xₙ to provide a Mₙ₊₁AXₙ.

Preferably, the treating a mixture of n+1M and nX to provide an ordered and/or twinned Mₙ₊₁Xₙ phase is a mechanical treatment, and more preferably the mechanical treatment involves mechanical alloying. Preferably the mechanical alloying is milling. Mechanical alloying is preferably milling of graphite and any suitable source of M. For example, if Ti₃SiC₂ is desired, mechanical alloying is between graphite or any suitable source of pure carbon and a Ti source such as, but not limited to TiH₂, TiO₂, Ti powder.

According to a third aspect, the invention provides a method of forming a Mₙ₊₁AXₙ compound, where M is an early transition metal or mixtures thereof, A is Si, Ge, Al or mixtures thereof and X is C, N or mixtures thereof, comprising:

treating a mixture of n+1M and nX in the presence of A to provide an ordered and/or twinned Mₙ₊₁Xₙ phase
and
treating the mixture of A and Mₙ₊₁Xₙ to provide a Mₙ₊₁AXₙ.

The ordered and/or twinned phase may be formed in conjunction with element A, which may facilitate ordering and/or twinning

The present invention relates to the use of Mₙ₊₁Xₙ as a precursor for Mₙ₊₁AXₙ.

In particular, the invention relates to the use of Ti₃C₂ phases in the preparation of Ti₃SiC₂. Those skilled in the art will be aware that Ti₃C₂ is sometimes referred to as TiC_{0.67} and the two forms are used herein interchangeably.

According to a fourth aspect, the invention provides a method of forming Mₙ₊₁AXₙ comprising combining twinned Mₙ₊₁Xₙ with A. Preferably, the method includes thermal treatment to insert Si into twinned Ti₃C₂.

According to a fifth aspect, the invention provides ultra pure Mₙ₊₁AXₙ. By ultra pure is meant that the Mₙ₊₁AXₙ is substantially free from MX or other residual phases, ie it is substantially free from starting materials or other impurities. MX is <5% of the total Mₙ₊₁AXₙ, preferably less than 1% and more preferably less than 0.5%. Percentages, where not specified, relate to mole %.

In one particular embodiment, the invention provides ultra pure Ti₃SiC₂ having no or substantially no TiC, Ti₅Si₃ or other impurity phases. In other particular embodiments, the invention provides Ti₃SiC₂ having no or substantially no unwanted impurities, but containing a predetermined amount of another phase, for example Ti₃SiC₂ with a predetermined amount of TiC.

According to a sixth aspect the invention provides an ordered Mₙ₊₁Xₙ phase According to a seventh aspect the invention provides a twinned Mₙ₊₁Xₙ phase

An advantage of these ordered and or twinned precursors is that they readily facilitate the introduction of the A species such as silicon. Not only does this lead to increased purity, it also decreases the cost of production. This occurs because the need to decompose highly stable intermediate phases such as TiC and Ti₅Si₃ is circumvented. High temperature furnaces are costly to purchase, operate and maintain and reducing the synthesis temperature from 1400-1600° C. to below 1100° C. significantly reduces the energy requirement and the degree of sophistication of the furnace required to carry out the process.

The present approach also enables the possibility of selected alloying or doping by partial replacement of any or all of the M, A or X species. For example, a twinned or ordered Mₙ₊₁Xₙ phase can be mixed with a stoichiometric amount of A if required to produce pure Mₙ₊₁AXₙ. However, if deemed desirable, a predetermined substoichiometric quantity. Other elements, or mixtures of elements, can be doped in at this stage in a controlled manner.

Ti₃SiC₂ belongs to a large group of ternary carbides that exhibit a unique combination of high temperature ceramic properties with the electrical and thermal conductivity of metals. As mentioned above, while these compounds are potentially very useful, their full potential to date is limited by the presence of residual intermediate compounds and starting materials that result in a degradation of these properties. The present invention seeks to reduce or eliminate the presence of unreacted intermediates by employing ordered and/or twinned precursors which provide a direct path to the product MAX phase. In the case of Ti₃SiC₂, the present invention employs a custom engineered crystalline phase precursor, Ti₃C₂, which can circumvent intermediate compound formation.

Without wishing to be bound by theory, it is believed that by using structural units common to the product phase, the crystalline precursors improve purity by effecting product formation at an atomic level in a controlled manner.

### BRIEF DESCRIPTION OF THE DRAWINGS

FIG. 1 shows one possible mechanism behind the engineering of Ti₃SiC₂ from a TiC_{0.67} precursor.

FIG. 2 shows one possible mechanism behind silicon diffusion through random vs ordered TiCₓ phases.

FIG. 3a shows the efficacy of mechanical milling in making the raw materials more reactive; in this case a reduction in the SHS combustion temperature of Ti₃SiC₂ as a function of milling time.

FIG. 3b shows the temperature profile of the exterior of the milling vial during the mechanical alloying reaction.

FIG. 4 shows real-time changes in the neutron diffraction data obtained during one embodiment of the invention.

FIG. 5 shows a series of BSE (back scattered electron) images from samples containing 3Ti+SiC+C milled for 15, 30, 45, 60, 75 and 90 minutes.

### DESCRIPTION

As mentioned above, the present invention will be generally described with reference to Ti₃SiC₂ as an example, although it will be appreciated that the scope of the invention is not limited to this particular example but encompasses all compounds of the general Mₙ₊₁AXₙ formula, their solid solutions and composites based upon them.

To date, the synthesis of bulk Ti₃SiC₂ has been attempted by a wide variety of methods, such as M. W. Barsoum, T. El-Raghy, J. Am. Ceram. Soc., Vol. 79, 1953-56 (1996); J. Mat. Synth. and Proc., Vol. 5, [3], pp. 197-216, 1997; J. Am. Ceram. Soc., Vol. 82, 2849-54 (1999); J. Am. Ceram. Soc., Vol. 82, 2855-60 (1999); E. H. Kisi, J. A. A. Crossley, S. Myhra, M. W. Barsoum, J. Phys. Chem. Solids, Vol. 59, 1437-1443 (1998); S. Myhra, J. W. B. Summers, E. H. Kisi, Materials. Letters., Vol. 39, 6-11 (1999); T. Goto, T. Hirai, Mat. Res. Bull., Vol. 22, 1195-1201 (1987); R. Pampuch, J. Lis, J. Piekarczyk, L. Stobierski”, J. Mat. Synth. & Proc., Vol. 1, 2, 93-100 (1993); F. Goesmann, R. Schmid-Fetzer, Mat. Sci, & Engng., Vol. B46, 357-362 (1997); F. Goesmann, R. Wenzel, R. Schmid-Fetzer, J. Am. Ceram. Soc., 81, 11, 3025-3028 (1998); A. Feng, T. Orling, Z. A. Munir, J. Mater. Res., Vol. 14, 3, 925-939 (1998).

These synthetic methods have met with various degrees of success, however, even the best technique (reactive hot pressing) can result in up to 5% of unwanted TiC present in the final product. Generally, the more economical the method, the higher the impurity levels. Combustion synthesis, perceived as the most economical method, has TiC impurity levels above 5%.

Although a variety of different reactive pathways are employed in the abovementioned documents, there are commonalities of processing temperatures (>1400° C.) and reactants used (either 3Ti+Si+2C or 3Ti+SiC+C). The latter combination was found in some cases to improve the purity of the product material obtained.

Throughout the literature, there has been a considerable reliance on post-reaction microstructure analyses, often leading to incorrect assumptions of how the reaction proceeds. Without wishing to be bound by theory, the present inventors established by in-situ neutron diffraction that, depending on the synthesis method, Ti₃SiC₂ evolves from binary and ternary phases that can provide the key to a more controlled synthesis.

It was observed that during reactive sintering from 3Ti+SiC+2C starting materials, two intermediate phases, TiCₓ and Ti₅Si₃Cₓ form, initially with very low concentrations of carbon (x≅0.4). They simultaneously increase in quantity and become more stoichiometric (i.e. x→1.0) until they dominate the microstructure. Ti₃SiC₂ grows via a solid-state reaction between the two intermediates. Once the TiCₓ attains a value of x≅1.0, conversion to the product phase virtually ceases. The diffusion-controlled reaction is limited by the rate at which silicon can diffuse through TiCₓ, with the rate slowing as x increases. This is compelling evidence that the TiCₓ intermediate phase must be sub-stoichiometric to allow for the precipitation of Ti₃SiC₂. Once fully stoichiometric, TiC cannot be fully removed from the product material in a reasonable time scale.

During in-situ neutron diffraction studies of combustion synthesis, a single psuedo-binary intermediate phase, essentially a solid solution of silicon in TiCₓ, was rapidly formed. Ti₃SiC₂ precipitated directly from this solid solution upon cooling, confirming that, under the correct conditions, large amounts of silicon can be incorporated within the TiCₓ structure.

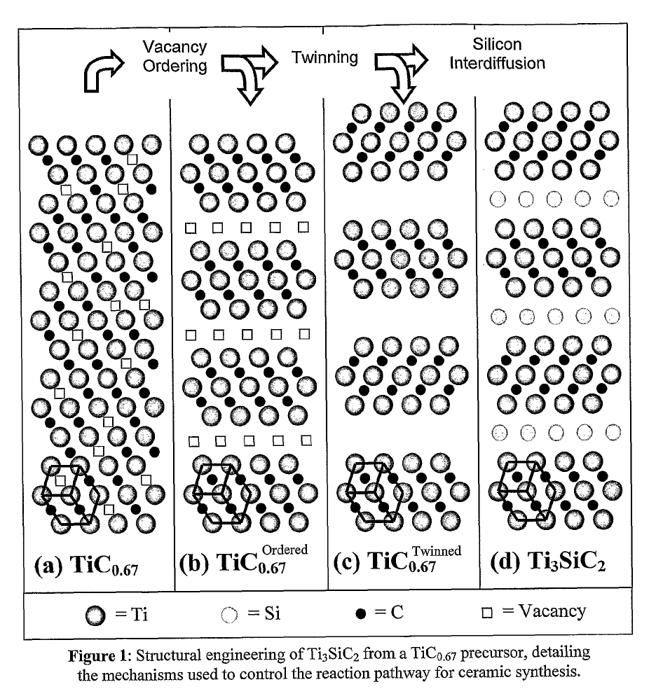

Hägg and Nowotny or MAX phases, including Ti₃SiC₂, contain structural units that are common to one or more lower order phases. Of particular relevance are the Ti₆C octahedra of which TiC is constructed and which can also be found repeated as ordered layers in Ti₃ SiC₂, as shown in FIGS. 1(a) and 1(d), respectively.

In Ti₃SiC₂ a single layer of Si atoms separates twinned layers of TiC, with an elongated Ti—Si bond joining the structure together. In Ti₃SiC₂ the double carbide layer (which is Ti₃C₂) must be fully occupied with carbon. In contrast, TiC may be sub-stoichiometric (TiCₓ) over a wide range of composition (TiC_{0.33} to TiC_{1.0}). Without wishing to be bound by theory, it is believed that the structural similarities between the designed precursor Ti₃C₂ described here and Ti₃SiC₂ form the basis for the high level of purity achieved in the synthesis of Ti₃SiC₂ using the method described herein.

A critical aspect of the present invention comes from understanding the crystallographic relationship between the TiC_{0.67} (Fm3m) and Ti₃SiC₂ (P6₃/mmc) structures. FIG. 1(a) illustrates a two-dimensional projection of the TiC_{0.67} (110) plane. In general, sub-stoichiometric TiCₓ contains only randomly distributed carbon vacancies, as indicated for TiC_{0.67}.

Various treatments can cause the vacancies on the octahedral site to form into ordered arrangements for example into layers. Ordering in TiCₓ is possible over a wide range of compositions—at least TiC_{0.5}—TiC_{0.87}. In TiC_{0.67} this ordered structure, illustrated in FIG. 1(b), is expressed one-dimensionally by the stacking sequence —Ti—C—Ti—C—Ti-□- (or equally Ti₃C₂-□-), where □=vacancy, a vacant carbon position within the structure. The vacancy ordering in this instance occurs in layers, accompanied by an enlargement of the vacant site as titanium atoms relax towards the carbon atoms. This and related forms of ordering are critical to the method developed here.

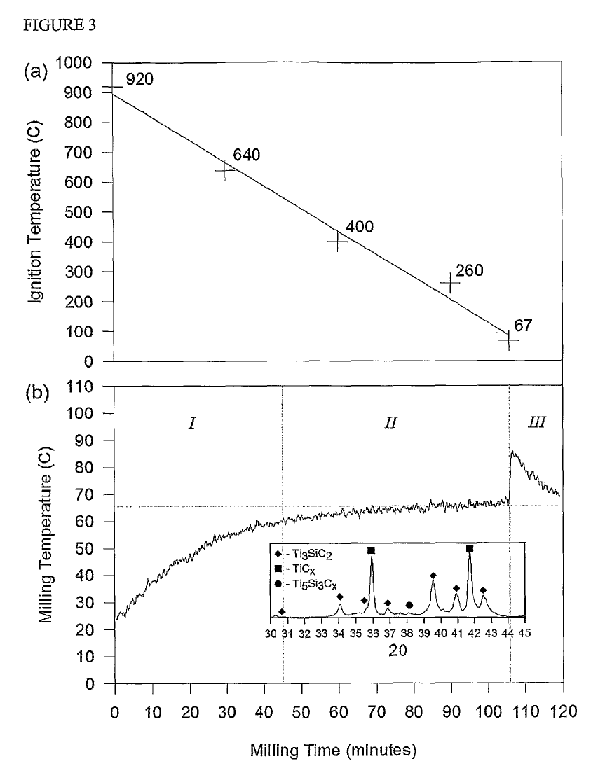

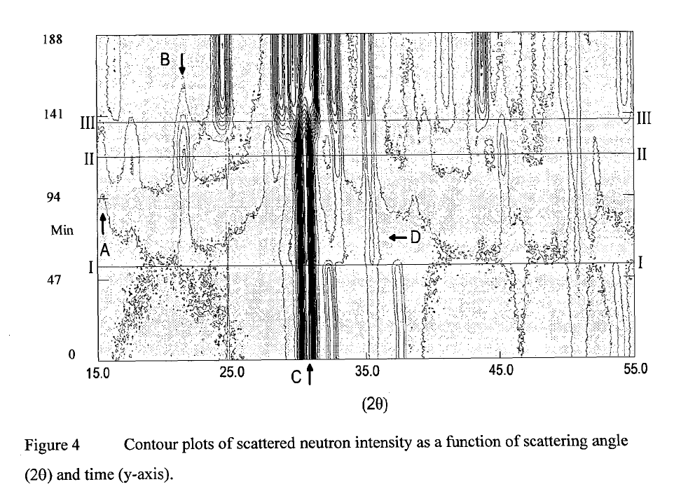

Previous examples of vacancy ordering in TiCₓ have been very slow processes, requiring annealing times of up to a month. It is known that the microstructure of mechanically milled materials is highly disordered, the diffusion rates over short distances are significantly higher than normal lattice diffusion and that this allows microstructural processes to occur much faster and at lower temperature. An example from the work of the inventors is the effect of mechanical milling on the temperature required to initiate a self-propagating high-temperature synthesis (SHS) reaction in 3Ti+SiC+C mixtures as shown in FIG. 3. Milling was found to lower the SHS ignition temperature by as much as 850° C. This reduction is equivalent to an increase in diffusivity of many orders of magnitude, and dramatically illustrates that pre-processing by MA is effective in altering the kinetic state of reactants, significantly reducing processing times and temperatures. The invention relies upon this higher mobility to allow vacancy ordering to occur on industrially realistic timeframes.

Short range ordering and twin faulting is known to exist in TiCₓ where silicon was present. Through either segregation of Si to pre-existing faults or by causing further enlargement of the vacant site, sub-stoichiometric TiCₓ was shown to have a higher than expected twin fault density when silicon was introduced into the system.

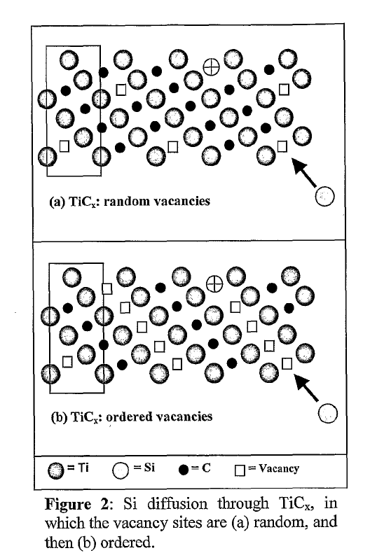

The preferential segregation of silicon to these enlarged stacking faults has been observed to be accompanied by the nucleation of Ti₅Si₃Cₓ and Ti₃SiC₂ itself. One possible, non limiting mechanism for the progressive ingress of silicon into the TiCₓ structure is illustrated by comparing FIGS. 1(c) and 1(d), a [1210] projection, demostrating that the ordered vacancies in TiC_{0.67} closely approximate the silicon positions in Ti₃SiC₂. The enlarged vacancies allow Si to preferentially diffuse into these sites without disrupting the ordering of the pre-existing Ti and C atoms. Again, without wishing to be bound by theory, FIG. 2, provides one particular model illustrating the significance of vacancy ordering in providing diffusion paths into the crystal structure.

FIG. 1 summarises the relationships between (a) TiC_{0.67}, (b) ordered TiC_{0.67}, (c) twinned TiC_{0.67}, and (d) Ti₃SiC₂ and serves to highlight their structural similarities, pointing the way to a new and highly versatile synthesis methodology using precursor phases. Used as a reactant material, the precursor Ti₃C₂ is structurally similar to (c) twinned TiC_{0.67}, with a deliberate, controlled ordering of carbon vacancies. Upon the addition of silicon, Ti₃SiC₂ is directly synthesized from this precursor phase without proceeding via any intermediate phases. The precursor is thus able to produce an alternate, continuous pathway to the product phase, eliminating residual impurity phases by preventing their initial formation. The key to designing and manufacturing such a specific precursor lies with understanding the structure and synthesis of Ti₃SiC₂ and controlling the ordering of TiC. In these compounds, the value of x can usually range from 0.44 to 1. Particularly preferred are TiC_{0.5}, a precursor to 2:1:1 MAX phases, TiC_{0.67}, a precursor to 3:1:2 MAX phases, and TiC_{0.75}, a precursor to 4:1:3 MAX phases.

The mechanistic pathway to Ti₃SiC₂ via a TiC_{0.67} (Ti₃C₂) precursor is shown primarily with reference to FIG. 1. The mechanism may be described by three key stages:
Vacancy ordering of sub-stoichiometric TiC_{0.67} FIG. 1 (a)→(b)
Twinning to re-align the structural units FIG. 1 (c)→(d)
Preferential diffusion of Si into the ordered vacancies, for using Ti₃SiC₂ FIG. 1 (b)→(c)

The three physical steps in the synthesis of Ti₃SiC₂ from a TiC_{0.67} precursor, which is one embodiment of the present invention is given below by way of a non-limiting example:

Milling Pre-Processing

Mechanical alloying (MA) of Ti (source TiH₂, TiO₂, Ti-powder etc) and C (graphite, glassy carbon, amorphous carbon etc) reactants forms a highly reactive, homogeneous powder. The degree of activation is proportional to the milling time, starting material particle size, milling energy and temperature. Microstructural analysis using Neutron/X-ray diffraction (ND/XRD) and Scanning Electron Microscopy (SEM) can be used to establish average particle size and morphology, respectively.

Once MA activated, the reactant powders were pressed and then annealed to allow solid state reaction to form TiC_{0.67}. The annealing time and temperature are dependent upon the degree of milling achieved in the previous step. Increased homogeneity and activation (i.e. increased milling) reduce both annealing time and temperature.

When the milling was continued for longer, the TiC_{0.67} precursor material was produced directly by a mechanically activated self-propagating high-temperature synthesis (MASHS) reaction within the mill. Unlike previously referenced techniques, no secondary heating stage was required giving a substantial saving in time and cost. The [C]/[Ti] concentration ratio can be quantified using ND and crystal structure refinements eg Rietveld analysis.

Order-Disorder Transition in TiC_{0.67} (FIG. 1(b))

In-situ neutron diffraction (ND) were used to identify ordering in the TiC_{0.67} precursor by looking at the (^{h}/₂,^{k}/₂,¹/₂) super-lattice reflections. Crystal structure refinements eg Rietveld analysis allow the degree of ordering to be determined. In addition, the C concentration can be simultaneously determined.

For example, using the D20 neutron diffractometer of the Institut Laue-Langevin (ILL, France), operating at a wavelength of λ=1.3 Å, the presence of superlattice reflections, eg at 15.5° and 29.6°(2θ) was confirmed in powders of the sub-stoichiometric precursor. This superlattice reflection is consistent with a degree of vacancy ordering. Additional analysis performed using time-resolved in-situ neutron diffraction (1 minute acquisitions, 10°-140° 2θ) identified no further ordering of the precursor material when independently heated from RT to 1000° C. at 5° C./min.

However, when the precursor was mixed with elemental Al in molar concentrations of 3:1 and subsequently heated from RT to 1000° C. at 5° C./min, spontaneous self-ordering of the precursor structure resulted and (see below) lead to the direct synthesis of Ti₃AlC₂. A similar effect was seen using Si in place of Al.

Reactive Sintering 3TiC_{0.67 Ordered}+Si→Ti₃SiC₂, 3TiC_{0.67 Ordered}+Al→Ti₃AlC₂ (FIG. 1(c)→(d))

The reactive sintering of the ordered MX precursor with A, such as the reaction of (TiC_{0.67 Ordered}) and silicon to form Ti₃SiC₂ or aluminium to form Ti₃AlC₂ can be studied using in-situ ND. Phase identification can be used to show the progress of Si or Al migration into the precursor, thus aiding control of the synthesis. Crystal structure analysis can be used to study the extent of Si diffusion onto the vacant carbon site, (x), in Ti₃SiₓC₂. The kinetics of this conversion can be studied using Quantitative Phase Analysis (QPA).

In-situ diffraction techniques allow detailed observation of reaction kinetics during processing. Due to their low absorption by most materials, neutrons will be the primary source of analysis for diffraction based experiments. This allows large quantities of material to be analysed during each experiment, thus reducing the influence of chemical and thermal gradients within the sample.

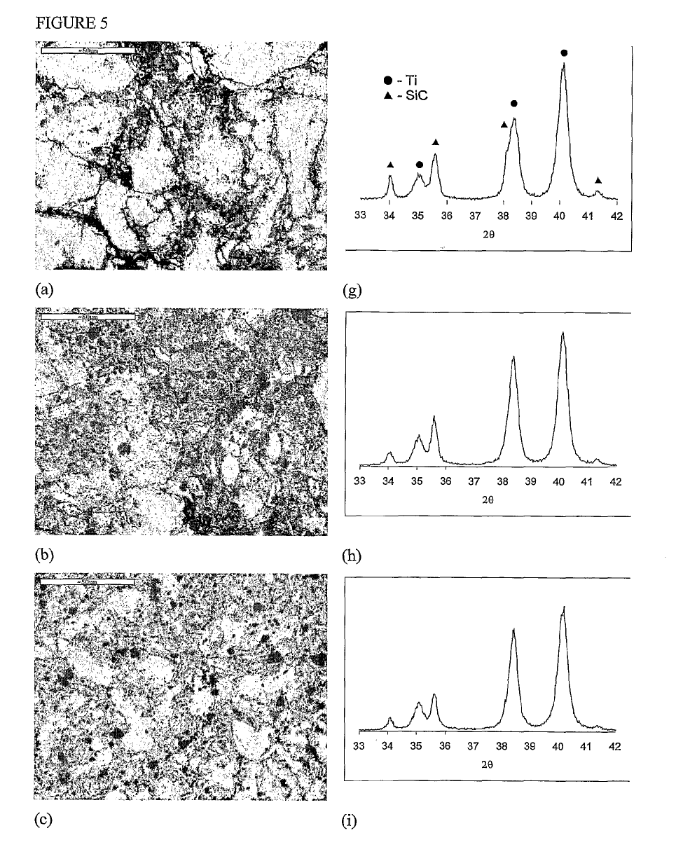

The complete reaction sequence was determined for the Ti₃SiC₂ and Ti₃AlC₂ examples using in-situ neutron diffraction and is illustrated in FIG. 4 for the aluminium case. FIG. 4 is a contour plot of scattered neutron intensity as a function of scattering angle (2θ) and time (y-axis). The horizontal lines mark the melting of Al at 660° C. (I), the centre of the zone where the precursor has absorbed the Al and has formed an ordered phase (II) and the mid-point of the precipitation of the Ti₃AlC₂ product phase (III). The precursor may be tracked using its strongest Bragg reflection indicated at C. The strongest Bragg reflection from the ordered precursor+Al is indicated by B and one of the Bragg reflections showing partial ordering in the as-milled TiC_{0.67} by the letter A. The letter D indicates diffuse scattering due to the molten Al. With particular reference to the reaction mechanism, the reaction was shown to be initiated by the melting of elemental Al at 660° C.; clearly identified at Point A by the disappearance of characteristic Al Bragg reflections. Simultaneous increases in the diffracted background after Point A are consistent with diffuse scattering from an amorphous phase (i.e. molten Al). As the remaining Bragg reflections index only to the initial precursor structure, this suggests a two-phase mixture of TiC_{0.67}+molten Al. Following steady heating towards 1000° C. at 5°/min the precursor structure began to spontaneously self-order, identified by the appearance of additional superlattice reflections approximately 45 mins after the initial Al liquification (Point B of FIG. 4). This stage can be sped up by faster heating (eg occurs in just 5 minutes when heated at 25°/min). Critically, the appearance of these accompanying superlattice reflections at around 700° C. was preceded by a reduction in the diffuse background, providing direct evidence of molten Al entering the TiC_{0.67} structure. Further evidence for Al ingress into the TiC_{0.67} is the simultaneous increase in the intensities of the TiC_{0.67} Bragg reflections. Once Al ingress and ordering is complete, the stacking sequence of the ordered precursor approximates the alternating sequence of Mₙ₊₁Xₙ(=Ti₃C₂) and Al layers characteristic of Ti₃AlC₂. Importantly, self-ordering of the precursor state on these very short timeframes has not been observed without the presence of an A species (Al, Si etc), indicating that A element ingress speeds up long range ordering by a factor that can exceed 8,000 (five minutes instead of up to one month). This point is a crucial demonstration that the self-assembly mechanism is triggered by the stabilising affects of Al entering and then ordering the defective precursor structure.

A final decrease in the superlattice intensities was shown to coincide with the precipitation of the Ti₃AlC₂ phase, confirming nucleation from the precursor material. Significantly, these results demonstrate that successful synthesis of Ti₃AlC₂ using an intercalating precursor can be achieved at temperatures as low as 1000° C., which is up to 600° C. below conventional synthesis techniques. Furthermore, the higher atomic mobility associated with this intercalation mechanism allow for an appreciable reduction in Ti₃AlC₂ synthesis time, down to <60 minutes and as little as 5 minutes. Similar results (without melting of the A element) have been observed in the system TiC_{0.67}+Si and are believed to be a general feature of such systems. The final reaction sequence is consistent with the schematic of FIG. 1, providing:

TiC_{0.67}+Al→TiC_{0.67}+molten Al→TiC_{0.67}(Al)→TiC_{0.67}(Al)(ordered)→Ti₃AlC₂

### Appendix I—Illustration of the Effect of Mechanical Milling

### 1. Experimental Procedure

Unless otherwise stated, all samples were prepared using high-purity powder mixtures of titanium (Sigma-Aldrich, −100 mesh, 99.98%), silicon carbide (Performance Ceramics, Japan, <100 μm, 99.9%) and graphite (Aldrich, <100 μm, 99.9%). Stoichiometric mixtures (3Ti+SiC+C) were weighed within a recirculated argon glove-box (<2 ppm O₂, <2 ppm H₂O). Mechanical alloying was performed using a SPEX8000 mill in a hardened steel milling vial loaded with six 5 mm and three 10 mm steel bearings. A 6.261 g charge of starting powder produced a ball to powder mass charge ratio of 10:1. Samples were milled for between 15 minutes and 120 minutes in 15-minute increments. A K-type thermocouple was attached to the exterior of the milling vial and sampled at 1 Hz.

Un-reacted mixtures milled for 0, 30, 60 and 90 minutes were cold pressed at 180 MPa into pellets of 16.2 mm diameter and 6 mm height. SHS ignition of each pellet was performed in a resistively-heated vanadium-element furnace, under a vacuum of 10⁻² Torr. An initial heating rate of 100° C./min was used, with a projected hold temperature of 1100° C. The ignition temperature was monitored via two K-type control thermocouples positioned within the heating element and close to the base of each sample.

Milled powders not used for SHS ignition experiments were divided for microstructural characterisation. Some of the mixture was vacuum infiltrated by epoxy resin, while the remainder was kept in powder form. Upon curing, the epoxy mounted samples were prepared for microanalysis by polishing with a 1-μm diamond suspension and sputter coated with an ultra-thin carbon film (˜20 nm). Scanning electron microscopy and microanalysis was conducted using a Philips XL30 fitted with an Oxford ISIS EDS system with a Be window detector. X-ray powder diffraction (XRD) patterns (10°-120° 2θ) were recorded from the loose powders using a Philips PW1810 and CuK_{α} radiation. Phase identification was performed with reference to the ICDD PDF Database and phase quantification performed using the Rietveld analysis scale factors and the LHPM-Rietica software. Parameters refined during Rietveld analysis were global parameters (zero offset and a fourth order polynomial background), scale factors, lattice parameters and the peak width parameters U and K initially for all phases, the latter only for Ti and SiC.

### 2. Results

### 2.1 Ignition Temperatures

Consolidated 3Ti+SiC+C samples, with no pre-milling, were shown to have an SHS ignition temperature of T_{ig}=920° C.±20° C. in earlier work. By pre-milling samples for 30, 60 and 90 minutes, the respective SHS ignition temperatures were reduced to 640° C.±20° C., 400° C.±20° C., and 260° C.±20° C., as shown in FIG. 3(a). By increasing the milling time to >105 min a spontaneous mechanically activated SHS (MASHS) reaction was achieved within the milling vial. The temperature profile of this reaction, indicating an exothermic response at 67° C.±3° C., is shown in FIG. 3(b).

Three distinct zones are apparent. In Zone I (0 to 45 min) there is a rapid temperature rise due to the milling action. In Zone II (45 to 105 min) the vial temperature continues to rise though at a significantly reduced rate due to increased losses to the surrounds. Zone III (105 to 120 min) begins with an abrupt temperature rise of ˜25° C. after 107 minutes of milling (Tᵥᵢₐₗ=67° C.) indicating an exothermic reaction within the milling vial. It should, however, be noted that the overall vial temperature is not the instantaneous ignition temperature of the SHS reaction, but rather the average temperature at which the reaction is spontaneously self-sustaining. This temperature excursion decays over the ensuing 15 minutes or so. The reaction was considered to have extinguished and the milling halted when the temperature of the milling vial returned to thermal equilibrium with its surrounds. X-ray diffraction of the product indicated two majority phases, Ti₃SiC₂ and substoichiometric TiCₓ as shown in the inset of FIG. 1(b). A minor amount of the silicide, Ti₅Si₃Cₓ is observed (e.g. by the peak at 38.2° 2θ). These product phases and their quantities are consistent with SHS reactions in dispersed 3Ti+SiC+C powders where discontinuity of the reactants limits inter-particle mass transport.

### 2.2 Changes to the Milled Powders

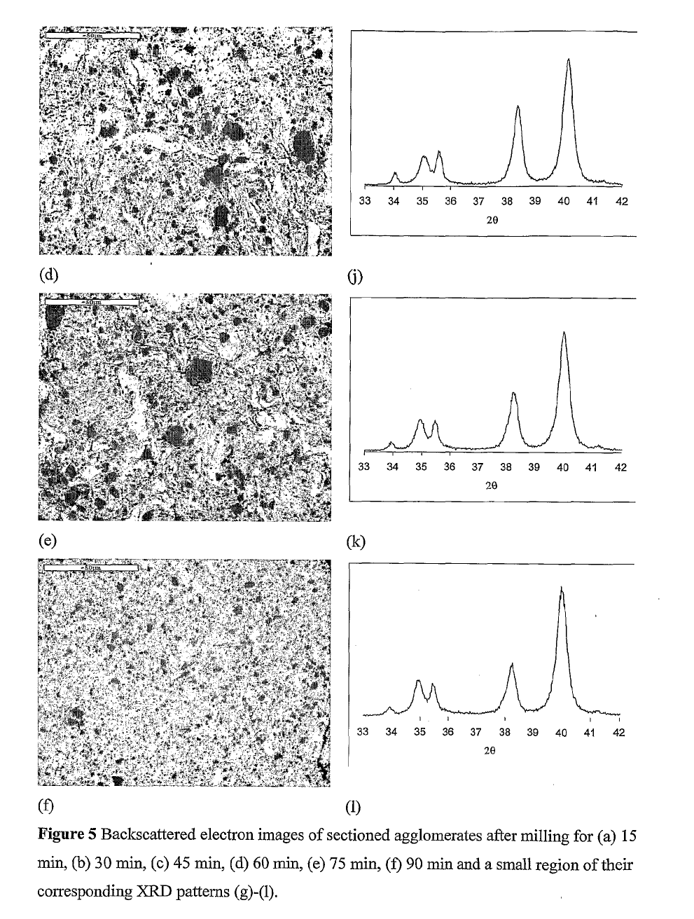

The milling induced morphological trends are illustrated in FIG. 5 with a series of BSE images from samples of 3Ti+SiC+C milled for 15, 30, 45, 60, 75 and 90 minutes. Also given are key regions of the corresponding XRD patterns. After only 15 minutes of milling, the Ti is relatively intact and the microstructure is primarily a mixture of the original powders. A slight amount of plastic deformation is visible around the margins of the Ti particles and a small amount of SiC has become incorporated in them. The XRD peaks are considerably broadened but show no new phases. As milling continues, the most striking feature of the BSE images in FIG. 5 is the effect of milling on the Ti particles. The undistorted core of the particles is progressively reduced in size until after 90 minutes of milling discrete Ti particles are hard to define in FIG. 5(f). The particles remain approximately equiaxed until, between 45 and 60 minutes of milling, lamellar structures within the Ti matrix are formed. These structures are identified by the elongated layering of the un-deformed and deformed Ti regions, more readily observed in FIGS. 5(d) and 5(e).

Unlike Ti, the SiC particles remain qualitatively the same size and shape with increased milling. Clearly the more ductile Ti phase absorbs the majority of the milling energy as it plastically deforms about the SiC particles. There is an accompanying systematic change in the SiC distribution. Initially the SiC particles merely fill the interstices between the much larger Ti particles (FIG. 5(a)). Later, there is considerable mixing of highly deformed Ti and relatively un-deformed SiC in the weld seams (FIGS. 5(b-f)). At very long milling times (e.g. 90 min, FIG. 5(f)) the larger SiC particles are finally broken down.

Within the weld seams between pure Ti particles, the interfacial contact area between Ti and SiC has increased by many orders of magnitude over the initial state. Overall, the mixing induced by high-energy milling appears to occur through the deformation of ductile Ti as it is conformed about the harder SiC particles. The rate of mixing, as judged by pure Ti particle size estimates, reduces as a function of milling time. After 90 minutes, mixing is nearly complete; however the rate is very slow. The trends in FIG. 5, suggest that reactant homogeneity is relatively high after 107 minutes milling, at which time combustion occurs spontaneously in the mill.

The partial XRD patterns included in FIGS. 5(g-l) illustrate several interesting features. The first is that, although the peaks rapidly broaden as crystallite sizes are reduced and internal strains around dislocations accumulate, the apparent broadening does not increase significantly for additional milling beyond 15 minutes. This is contrary to expectation, given the large changes in the observed ratio of deformed to un-deformed Ti in FIGS. 5(a-f). This observation is thought to be a sampling problem i.e. the X-rays are absorbed within a few microns of the surface and hence sample mostly the deformed exterior of any milled agglomerates that they encounter. The second interesting feature is that the Ti peaks shift to lower 20. This is most readily evident in the (002) Ti peak which is initially at 38.5° 2θ and partially resolved from the adjacent (013) SiC peak (see FIG. 5(g)). After an additional 15 min of milling, the two peaks have merged.

The peak shifts were quantified in the form of refined lattice parameters from the Rietveld analyses. Results are shown in FIG. 4 where it is apparent that both the a-axis and c-axis expand linearly with increased milling. This may be due either to Ti forming a solid solution with either C or Si, or as a result of increased defect densities formed during the milling process. SiC exhibits similar lattice parameter trends, however the relationship is not linear.

1. A method of forming Mₙ₊₁AXₙ, where M is an early transition metal or mixtures thereof, A is a group III or IV element or mixtures thereof and X is C, N or mixtures thereof, the method comprising the steps of:
providing a precursor of formula Mₙ₊₁Xₙ and
reacting the Mₙ₊₁Xₙ with A to provide Mₙ₊₁AXₙ.

2. A method according to claim 1 wherein the Mₙ₊₁Xₙ is ordered and/or twinned prior to reacting with A.

3. A method according to claim 2 wherein the Mₙ₊₁Xₙ is ordered and/or twinned during its formation from M and X.

4. A method according to claim 3 wherein A is present during the formation of Mₙ₊₁Xₙ from M and X.

5. A method according to claim 3 wherein Mₙ₊₁Xₙ is ordered and/or twinned by treatment of disordered Mₙ₊₁Xₙ.

6. A method according to claim 5 wherein A is present during the ordering and/or twinning of disordered Mₙ₊₁Xₙ.

7. A method according to any one of the preceding claims wherein A is Al, Si, P, S, Ga, Ge, As, Cd, In, Sn, Ti or Pb.

8. A method according to claim 7 wherein A is Si, Ge or Al.

9. A method according to claim 8 wherein A is Si.

10. A method according to any one of the preceding claims wherein M is Sc Ti V Cr, Zr, Nb, Mo, Hf. Ta or W.

11. A method according to claim 10 wherein M is Ti.

12. A method according to any one of the preceding claims wherein X is C.

13. A method according to any one of the preceding claims wherein n is an integer.

14. A method according to claim 13 wherein n is 1, 2, or 3.

15. A method according to claim 14 wherein n is 2.

16. A method according to any one of the preceding claims wherein Mₙ₊₁AXₙ is a Ti—Si—C, Ti—Ge—C, Ti—Al—C, Ti—Al—N or Ti—Si—N system.

17. A method according to claim 16 wherein Mₙ₊₁AXₙ is a Ti—Si—C system.

18. A method according to claim 17 wherein the Ti—Si—C system is Ti₃SiC₂.

19. A method according to claim 18 wherein Mₙ₊₁AXₙ is a Ti-Al—C system.

20. A method according to claim 19 wherein Mₙ₊₁AXₙ is a Tiₙ₊₁AlCₙ system.

21. A method according to claim 20 wherein the Tiₙ₊₁AlCₙ system is Ti₂AlC, Ti₃AlC₂ or Ti₄AlC₃.

22. A method according to any one of claims 2 to 21 wherein A is added to the ordered Mₙ₊₁Xₙ phase by mixing the two in powdered form.

23. A method according to any one of claims 2 to 21 wherein A is added to the ordered Mₙ₊₁Xₙ phase by gaseous phase or liquid phase mixing.

24. A method according to any one of the preceding claims wherein any or all of the M, A and X crystallographic sites are occupied by multiple elements.

25. A method according to any one of the preceding claims wherein M is any combination of early transition metals.

26. A method according to claim 25 wherein M is a combination of Ti and V.

27. A method according to claim 24 wherein A is a combination of Si and Al.

28. A method according to claim 24 wherein X is a combination of C and N.

29. A method according to claim 24 wherein Mₙ₊₁AXₙ is Ti₃SiₘAl₁₋ₘC₂, Ti_{y}V_{3-y}AlC₂ or Ti₃SiCₓN₂₋ₓ.

30. A method according to any one of the preceding claims wherein Mₙ₊₁Xₙ is mechanically treated to provide an ordered and/or twinned Mₙ₊₁Xₙ phase.

31. A method according to claim 30 wherein the mechanical treatment is mechanical alloying.

32. A method according to claim 31 wherein the mechanical alloying is milling.

33. A method according to claim 32 wherein the mechanical alloying is milling of graphite and any suitable source of M.

34. A method according to any one of the preceding claims wherein Mₙ₊₁Xₙ is thermally treated to provide an ordered and/or twinned Mₙ₊₁Xₙ phase.

35. A method according to any one of the preceding claims wherein reacting the Mₙ₊₁Xₙ with A to provide Mₙ₊₁AXₙ takes place with thermal treatment.

36. A method according to claim 35 wherein reacting the Mₙ₊₁Xₙ with A to provide Mₙ₊₁AXₙ is insertion of Si into twinned Ti₃C₂.

37. A method according to claim 35 or 36 wherein the thermal treatment is carried out at temperatures less than about 1100° C.

38. A method according to claim 35 wherein the thermal treatment is carried out at temperatures less than about 500° C.

39. A method of forming Mₙ₊₁AXₙ, where M is an early transition metal or mixtures thereof, A is a group III or IV element or mixtures thereof and X is C, N or mixtures thereof, comprising:
providing a precursor of formula Mₙ₊₁Xₙ;
treating Mₙ₊₁Xₙ if required to provide an ordered and/or twinned Mₙ₊₁Xₙ phase;
adding element A to the ordered Mₙ₊₁Xₙ phase; and
treating the mixture of A and Mₙ₊₁Xₙ to provide Mₙ₊₁AXₙ.

40. A method of forming Mₙ₊₁AXₙ where M is an early transition metal or mixtures thereof, A is Si, Ge, Al or mixtures thereof and X is C, N or mixtures thereof, comprising:
treating a mixture of n+1M and nX to provide an ordered and/or twinned Mₙ₊₁Xₙ phase
adding element A to the ordered Mₙ₊₁Xₙ phase
treating the mixture of A and Mₙ₊₁Xₙ to provide a Mₙ₊₁AXₙ.

41. A method of forming a Mₙ₊₁AXₙ compound, where M is an early transition metal or mixtures thereof, A is Si, Ge, Al or mixtures thereof and X is C, N or mixtures thereof, comprising:
treating a mixture of n+1M and nX in the presence of A to provide an ordered and/or twinned Mₙ₊₁Xₙ phase
and
treating the mixture of A and Mₙ₊₁Xₙ to provide a Mₙ₊₁AXₙ.

42. The use of Mₙ₊₁Xₙ as a precursor in the preparation of Mₙ₊₁AXₙ.

43. The use according to claim 42 wherein Ti₃C₂ (TiC_{0.67}) is a precursor in the preparation of Ti₃SiC₂.

44. Mₙ₊₁AXₙ substantially free from MX and or other residual phases.

45. Mₙ₊₁AXₙ according to claim 44 wherein MX is <5 mole % of the total.

46. Mₙ₊₁AXₙ according to claim 45 wherein MX is <1 mole % of the total.

47. Mₙ₊₁AXₙ according to claim 44 wherein MX is <0.5 mole % of the total.

48. Ti₃SiC₂ substantially free from TiC, Ti₅Si₃ or other impurity phases.

49. Ti₃SiC₂ containing a no more than a predetermined amount of another phase.

50. Ti₃SiC₂ according to claim 495 containing a no more than a predetermined amount of TiC.

51. An ordered Mₙ₊₁Xₙ phase.

52. A twinned Mₙ₊₁Xₙ phase.

53. A composite material based on Mₙ₊₁AXₙ substantially free from MX and or other residual phases.

54. A composite material according to claim 53 comprising a matrix of Ti₃SiC₂ with embedded TiC particles.

55. A composite material according to claim 53 in the form of oxide ceramics which have a layered structure.
